(19) United States
(12) Patent Application Publication
(10) Pub. No.: US 2021/0309053 A1
(43) Pub. Date: Oct. 7, 2021

(54) Pneumatic Tire

(71) Applicant: The Yokohama Rubber Co., LTD., Minato-ku, Tokyo (JP)

(72) Inventors: Kazuya Ishiguro, Hiratsuka-shi, Kanagawa (JP); Takashi Hoshiba, Hiratsuka-shi, Kanagawa (JP); Masahiro Naruse, Hiratsuka-shi, Kanagawa (JP)

(21) Appl. No.: 17/262,681

(22) PCT Filed: Jul. 17, 2019
(86) PCT No.: PCT/JP2019/028154

§ 371 Date: Jan. 22, 2021

(30) Foreign Application Priority Data
Jul. 24, 2018 (JP) 2018-138610

(51) Int. Cl. B60C 19/00; B60C 5/14; B60C 11/24; B60C 23/04; B29D 30/00

(52) U.S. Cl. CPC B60C 19/00; B60C 5/14; B60C 11/243; B29D 2030/0077; B29D 30/0061; B60C 2019/004; B60C 23/0493

(57) ABSTRACT

Provided is a pneumatic tire. At least one sensor unit including a sensor that acquires tire information is fixed to an innerliner constituting a tire inner surface, and the sensor unit is bonded to the tire inner surface via an adhesive layer in a state where a release agent present in the tire inner surface is removed by cutting at least in a fixing region for the sensor unit.

### TECHNICAL FIELD

The present technology relates to a pneumatic tire including a sensor unit that acquires tire information, and particularly relates to a pneumatic tire that can provide enhanced adhesiveness between a tire inner surface and a sensor unit while ensuring air retention properties.

### BACKGROUND ART

To acquire tire internal information such as internal pressure and temperature, various sensors are installed in a tire cavity (for example, see Japan Patent No. 6272225 and Japan Unexamined Patent Publication No. 2016-505438).

Typically, a pneumatic tire is vulcanized in a state where a release agent is applied to a tire inner surface with which a bladder is in contact, and thus after vulcanization, the release agent remains applied to the tire inner surface. Thus, in the case of bonding a sensor unit to the tire inner surface after vulcanization, it is required to remove the release agent from the tire inner surface to ensure the adhesiveness between the tire inner surface and the sensor unit. A method for removing the release agent applied to the tire inner surface is, for example, cleaning treatment. However, this method does not sufficiently remove the release agent in the tire inner surface, and thus there is such a problem that the adhesiveness between the tire inner surface and the sensor unit cannot be ensured sufficiently, and that falling off of the sensor unit occurs.

### SUMMARY

The present technology provides a pneumatic tire that can provide enhanced adhesiveness between a tire inner surface and a sensor unit while ensuring air retention properties.

A pneumatic tire includes at least one sensor unit including a sensor that acquires tire information, and the sensor unit is fixed to an innerliner constituting a tire inner surface. The sensor unit is bonded to the tire inner surface via an adhesive layer in a state where a release agent present in the tire inner surface is removed by cutting at least in a fixing region for the sensor unit.

According to an embodiment of the present technology, at least one sensor unit including a sensor that acquires tire information is fixed to an innerliner constituting a tire inner surface, and the sensor unit is bonded to the tire inner surface via an adhesive layer in a state where a release agent present in the tire inner surface is removed by cutting at least in a fixing region for the sensor unit. Thus, the adhesiveness between the tire inner surface and the sensor unit can be enhanced while ensuring air retention properties.

In an embodiment of the present technology, preferably, a thickness Wa of the innerliner in the fixing region for the sensor unit ranges from 15% to 95% of a thickness Wb of the innerliner in a region other than the fixing region for the sensor unit. Accordingly, the adhesiveness between the tire inner surface and the sensor unit can be enhanced effectively while ensuring air retention properties. Additionally, tire productivity can be enhanced effectively.

In an embodiment of the present technology, preferably, a thickness Wa of the innerliner in the fixing region for the sensor unit, a thickness Wb of the innerliner in the region other than the fixing region for the sensor unit, and a thickness Wc of the adhesive layer in the fixing region for the sensor unit satisfy a relationship of Wb≥Wa+Wc. Accordingly, the existing heat dissipation of the innerliner is ensured, and thus the high-speed durability of the pneumatic tire can be maintained.

In an embodiment of the present technology, preferably, adhesive strength of the adhesive layer ranges from 0.4 N/mm² to 100 N/mm². Accordingly, work of installing the sensor unit can be performed easily while maintaining good adhesive strength of the adhesive layer. The adhesive strength (tensile shear adhesive strength) of the adhesive layer complies with any of JIS (Japanese Industrial Standard)-K6850 and JIS-Z0237, and is measured in a standard state (23° C. and RH 50%).

In an embodiment of the present technology, preferably, the adhesive layer is made of a cyanoacrylate-based adhesive. Accordingly, time for work of installing the sensor unit can be reduced.

In an embodiment of the present technology, preferably, the sensor unit is disposed in an inner side of a ground contact edge in a tire width direction. Accordingly, in a case of a sensor that detects an amount of wear of a tread portion, the sensor can accurately acquire tire information.

In an embodiment of the present technology, preferably, the sensor unit is bonded directly to the tire inner surface. Accordingly, in a case of a sensor that detects an amount of wear of a tread portion, the sensor can accurately acquire tire information.

In an embodiment of the present technology, preferably, a base is inserted between the sensor unit and the adhesive layer. Accordingly, in a case where a material that can follow tire deformation is used as a material for the base, peeling of the sensor unit due to the tire deformation can be prevented.

In an embodiment of the present technology, preferably, as roughness of the tire inner surface in the fixing region for the sensor unit, arithmetic mean roughness Ra ranges from 0.3 μm to 15.0 μm and/or a maximum height Ry ranges from 2.5 μm to 60.0 μm. Accordingly, the adhesion area of the tire inner surface and the adhesive layer can be increased, and the adhesiveness between the tire inner surface and the sensor unit can be enhanced effectively. The roughness of the tire inner surface is measured in accordance with JIS-B0601. Specifically, the arithmetic mean roughness Ra is a value determined by the following mathematical formula and expressed by micrometers (μm) in a case where a portion of a roughness curve is extracted only by a reference length 1 in a direction of an average line of the roughness curve, an X axis is set in the direction of an average line of the extracted portion, a Y axis is set in a direction of longitudinal magnification, and a roughness curve is expressed by y=f(x). On the other hand, the maximum height Ry is a value obtained by extracting a portion of a roughness curve only by the reference length 1 in the direction of an average line of the roughness curve, and measuring an interval between a ridge top line and a valley bottom line of the extracted portion in the direction of longitudinal magnification of the roughness curve, and is the value expressed by micrometers (μm). Note that, in a case where the maximum height Ry is determined, only the reference length 1 is extracted from a portion including no extraordinarily high ridge or low valley that is considered as a scratch.

$$\frac{1}{l} {\int }_{0}^{l} \vert f ( x ) \vert dx \qquad ( 1 )$$

In an embodiment of the present technology, ground contact edge refers to an end portion in the tire axial direction of a tire mounted on a regular rim and inflated to a regular internal pressure, and placed vertically on a flat surface with a regular load applied to the tire. “Regular rim” refers to a rim defined by a standard for each tire according to a system of standards that includes standards with which tires comply, and is a “standard rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). In a system of standards including standards with which tires comply, “regular internal pressure” refers to air pressure defined by each of the standards for each tire and is “maximum air pressure” defined by JATMA, a maximum value described in the table “TIRE LOAD LIMITS AT VARIOUS COLD INFLATION PRESSURES” defined by TRA, or “INFLATION PRESSURE” defined by ETRTO. However, “regular internal pressure” is 250 kPa in a case where a tire is a tire for a passenger vehicle. “Regular load” is a load defined by a standard for each tire according to a system of standards that includes standards with which tires comply, and is a “maximum load capacity” defined by JATMA, a maximum value described in the table “TIRE LOAD LIMITS AT VARIOUS COLD INFLATION PRESSURES” defined by TRA, or “LOAD CAPACITY” defined by ETRTO. However, “regular load” is a load corresponding to 80% of the load described above in a case where a tire is a tire for a passenger vehicle.

### BRIEF DESCRIPTION OF DRAWINGS

FIG. 1 is a meridian cross-sectional view illustrating an example of a pneumatic tire according to an embodiment of the present technology.

FIG. 2 is an enlarged cross-sectional view of a portion of the pneumatic tire of FIG. 1.

FIG. 3 is a cross-sectional view of a modified example of a pneumatic tire according to an embodiment of the present technology.

FIG. 4 is a perspective view of another modified example of a pneumatic tire according to an embodiment of the present technology.

### DETAILED DESCRIPTION

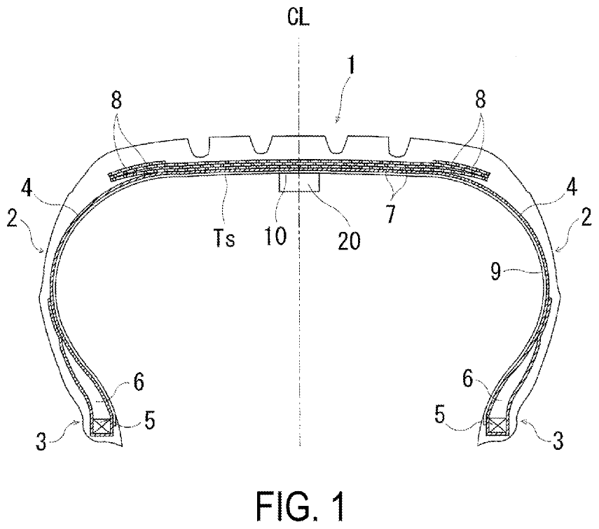

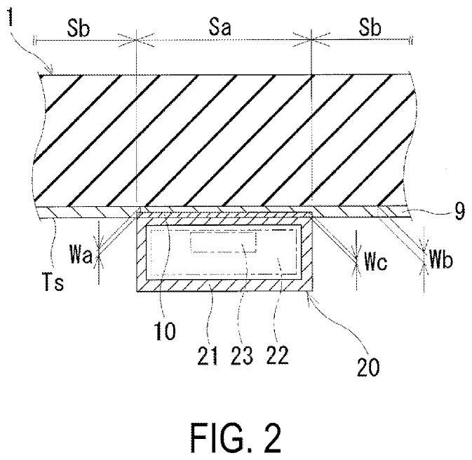

Configurations of embodiments of the present technology will be described in detail below with reference to the accompanying drawings. FIGS. 1 and 2 illustrate a pneumatic tire according to an embodiment of the present technology. Note that in FIG. 1, CL denotes a tire center line.

As illustrated in FIG. 1, a pneumatic tire according to an embodiment of the present technology includes a tread portion 1 having an annular shape and extending in the tire circumferential direction, a pair of sidewall portions 2, 2 disposed in both sides of the tread portion 1, and a pair of bead portions 3, 3 disposed in inner sides of the sidewall portions 2 in the tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on an outer circumference of the bead core 5. Then, an innerliner 9 is disposed in a region between the pair of bead portions 3, 3 in the tire inner surface. The innerliner 9 forms a tire inner surface Ts.

On the other hand, a plurality of belt layers 7 are embedded in an outer circumferential side of the carcass layer 4 in the tread portion 1. The belt layers 7 include a plurality of reinforcing cords that are inclined with respect to the tire circumferential direction, and are disposed with the reinforcing cords intersecting each other between the layers. In the belt layers 7, an inclination angle of the reinforcing cords with respect to the tire circumferential direction is set within the range of from 10° to 40°, for example. Steel cords are preferably used as the reinforcing cords of the belt layers 7. To improve high-speed durability, at least one belt cover layer 8 formed by arranging reinforcing cords at an angle of, for example, not greater than 5° with respect to the tire circumferential direction is disposed in the outer circumferential side of the belt layers 7. Organic fiber cords such as nylon, and aramid are preferably used as the reinforcing cords of the belt cover layer 8.

Note that the tire internal structure described above represents a typical example for a pneumatic tire, but is not limited to this.

In the pneumatic tire described above, at least one sensor unit 20 is fixed in a region corresponding to the tread portion 1 of the tire inner surface Ts. As illustrated in FIG. 2, the sensor unit 20 is bonded to the tire inner surface Ts via an adhesive layer 10.

The tire inner surface Ts includes a fixing region Sa for the sensor unit 20 and a region Sb other than the fixing region Sa for the sensor unit 20. The tire inner surface Ts is in a state where a release agent is removed at least in the fixing region Sa for the sensor unit 20. State where release agent is removed refers to a state where no release agent is present or a trace amount of the release agent remains in the fixing region Sa for the sensor unit 20 due to cutting (so-called buffing) of the tire inner surface Ts. Such work of removing the release agent is performed on the tire inner surface Ts of a vulcanized pneumatic tire after the release agent is applied to the tire inner surface of the green tire and vulcanization molding is performed. On the other hand, in the region Sb other than the fixing region Sa for the sensor unit 20, the release agent is not removed, and thus the release agent is present in a state in which the release agent is after vulcanization molding.

In a case where the release agent remains in the fixing region Sa for the sensor unit 20, an amount of silicon in the release agent is preferably equal to or less than 10.0 wt %. In an embodiment of the present technology, in defining an amount of the release agent in the tire inner surface Ts, an amount of silicon that is a main component of a typical release agent is used as an indicator. This amount of silicon can be detected by using an FP method (Fundamental Parameter method) of fluorescent X-ray analysis.

The adhesive layer 10 can include a liquid adhesive or a double sided adhesive tape. Examples of the adhesive include a reaction curable adhesive including an epoxy resin or a urethane resin. Particularly, the adhesive layer 10 may include a cyanoacrylate-based adhesive (instantaneous adhesive) to reduce working time for installing the sensor unit 20 in the tire inner surface Ts.

The sensor unit 20 includes a housing 21 and an electronic component 22. The housing 21 has a hollow structure, and accommodates the electronic component 22 inside. The electronic component 22 includes a sensor 23 that acquires tire information, a transmitter, a receiver, a control circuit, a battery, and the like as appropriate. Examples of the tire information acquired by the sensor 23 include internal temperature and internal pressure of the pneumatic tire, and an amount of wear of the tread portion 1. For example, a temperature sensor or a pressure sensor is used to measure internal temperature or internal pressure. In a case where an amount of wear of the tread portion 1 is detected, a piezoelectric sensor that comes into contact with the tire inner surface Ts can be used as the sensor 23, and the piezoelectric sensor detects an output voltage corresponding to deformation of a tire during traveling, and detects an amount of wear of the tread portion 1 based on the output voltage. Moreover, an acceleration sensor or a magnetic sensor can also be used. Additionally, the sensor unit 20 is configured to transmit the tire information acquired by the sensor 23 to an outside of the tire. Note that the internal structure of the sensor unit 20 illustrated in FIG. 2 is an example of the sensor unit, and is not limited to this.

In the pneumatic tire described above, at least one sensor unit 20 including a sensor 23 that acquires tire information is fixed to the innerliner 9 constituting the tire inner surface Ts, and the sensor unit 20 is bonded to the tire inner surface Ts via the adhesive layer 10 in a state where the release agent present in the tire inner surface Ts is removed by cutting in the fixing region Sa for the sensor unit 20. Thus, the adhesiveness between the tire inner surface Ts and the sensor unit 20 can be enhanced while ensuring air retention properties.

In FIG. 1 and FIG. 2, the sensor unit 20 is disposed in an inner side of the ground contact edge in the tire width direction. In the case of the sensor 23 that detects an amount of wear of the tread portion 1, the sensor unit 20 is disposed in this way, and thus the sensor 23 can accurately acquire the tire information.

Additionally, the sensor unit 20 is bonded directly to the tire inner surface Ts. In the case of the sensor 23 that detects an amount of wear of the tread portion 1, the sensor unit 20 is bonded directly to the tire inner surface Ts in this way, and thus the sensor 23 can accurately acquire the tire information.

In the pneumatic tire described above, the thickness of the innerliner 9 in the fixing region Sa for the sensor unit 20 is designated as a thickness Wa (see FIG. 2), and the thickness of the innerliner 9 in the region Sb other than the fixing region Sa for the sensor unit 20 is designated as a thickness Wb (see FIG. 2). At this time, the thickness Wa preferably ranges from 15% to 95% of the thickness Wb. Particularly, the thickness Wa more preferably ranges from 30% to 80% and most preferably ranges from 45% to 65%. The thickness Wa is appropriately set with respect to the thickness Wb in this way, and thus the adhesiveness between the tire inner surface Ts and the sensor unit 20 can be enhanced effectively while ensuring air retention properties. Additionally, tire productivity can be enhanced effectively. Here, when the ratio of the thickness Wa to the thickness Wb is less than 15%, air retention properties tend to decrease, whereas, when the ratio of the thickness Wa to the thickness Wb is more than 95%, the adhesiveness between the tire inner surface Ts and the sensor unit 20 degrades, and the sensor unit 20 easily peels.

Note that the thickness Wa of the innerliner 9 in the fixing region Sa for the sensor unit 20 is an average value of the thicknesses of the innerliner 9 measured at a total of five locations including a center point of the fixing region Sa for the sensor unit 20, two locations in both sides in the tire circumferential direction with the center point as the center, and two locations in both sides in the tire width direction with the center point as the center. On the other hand, the thickness Wb of the innerliner 9 in the region Sb is an average value of the thicknesses of the innerliner 9 measured at a total of four locations including two locations in both sides in the tire circumferential direction with the fixing region Sa for the sensor unit 20 as the center and two locations in both sides in the tire width direction with the fixing region Sa for the section unit 20 as the center.

Additionally, the thickness Wa of the innerliner 9 in the fixing region Sa for the sensor unit 20, the thickness Wb of the innerliner 9 in the region Sb, and a thickness Wc of the adhesive layer 10 in the fixing region Sa for the sensor unit 20 (see FIG. 2) preferably satisfy the relationship Wb≥Wa+Wc. Satisfying the relationship formula described above, the existing heat dissipation of the innerliner 9 is ensured, and thus the high-speed durability of the pneumatic tire can be maintained. On the other hand, in a case where the relationship formula described above is not satisfied, in other words, in a case where the relationship Wa+Wc>Wb is satisfied, the heat dissipation of the tire inner surface Ts (innerliner 9) decreases, and the high-speed durability of the pneumatic tire tends to degrade.

In the pneumatic tire described above, the adhesive strength of the adhesive layer 10 preferably ranges from 0.4 N/mm² to 100 N/mm². Particularly, the adhesive strength preferably ranges from 5.0 N/mm² to 80 N/mm². The adhesive strength of the adhesive layer 10 is appropriately set in this way, and thus work of installing the sensor unit 20 can be performed easily while maintaining good adhesive strength of the adhesive layer 10. Here, when the adhesive strength of the adhesive layer 10 is less than 0.4 N/mm², the adhesiveness between the tire inner surface Ts and the sensor unit 20 degrades, and the sensor unit 20 easily peels. On the other hand, when the adhesive strength of the adhesive layer 10 is more than 100 N/mm², replacement work in replacing the sensor unit 20 cannot be performed easily.

Additionally, as the roughness of the tire inner surface Ts in the fixing region Sa for the sensor unit 20, the arithmetic average roughness Ra preferably ranges from 0.3 μm to 15.0 μm, and/or the maximum height Ry preferably ranges from 2.5 μm to 60.0 μm. The roughness of the tire inner surface Ts is appropriately set in this way, and thus the adhesion area of the tire inner surface Ts and the adhesive layer 10 can be increased, and the adhesiveness between the tire inner surface Ts and the sensor unit 20 can be enhanced effectively.

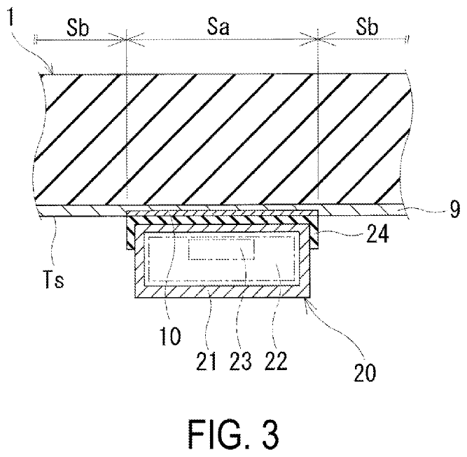

FIG. 3 illustrates a modified example of a pneumatic tire according to an embodiment of the present technology. As illustrated in FIG. 3, a base 24 that holds a sensor unit 20 is inserted between the sensor unit 20 and an adhesive layer 10. The base 24 functions as a cushioning material to prevent the sensor unit 20 from peeling due to tire deformation. As a material for the base 24, natural rubber (NR), chloroprene rubber (Cr), butyl rubber (IIR), ethylene-propylene-diene rubber (EPDM), urethane rubber, NBR, a thermoplastic elastomer, and a thermosetting elastomer can be exemplified. In a case where the base 24 is made of any of these materials, the base 24 is less likely to be damaged by tire deformation. Particularly, the base 24 may be made of rubber having tensile elongation at break of 80% or more. Additionally, the base 24 is preferably in a solid state, and is more preferably porous. In a case where the base 24 is porous, the base 24 has an excellent cushioning effect and is advantageous against peeling of the sensor unit 20 due to tire deformation. The base 24 is made of any of the above-described materials, and thus the base 24 can follow tire deformation, and can prevent peeling of the sensor unit 20 due to tire deformation. Note that, in the embodiment illustrated in FIG. 3, the example in which the base 24 is formed in a U shape in a cross-sectional view in the tire width direction is described, but the shape of the base 24 is not particularly limited. In FIG. 3, a fixing region Sa for the sensor unit 20 corresponds to a fixing region for the base 24 that holds the sensor unit 20. In the fixing region Sa for the sensor unit 20, a release agent is removed by cutting.

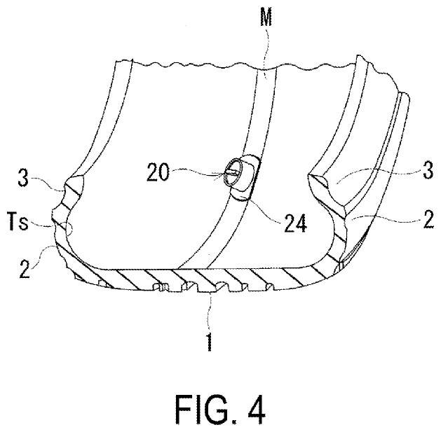

FIG. 4 illustrates another modified example of a pneumatic tire according to an embodiment of the present technology. As illustrated in FIG. 4, a sensor unit 20 is bonded to a smooth surface M of a tire inner surface Ts via an adhesive layer 10. The smooth surface M is formed in a central portion in the tire width direction in performing vulcanization molding by using a bladder. The smooth surface M is an annular flat surface extending in the tire circumferential direction. In a case where the sensor unit 20 is disposed on the smooth surface M of the tire inner surface Ts, the adhesiveness between the tire inner surface Ts and the sensor unit 20 can be enhanced effectively. Note that in FIG. 4, a fixing region Sa for the sensor unit 20 corresponds to a fixing region for a base 24 that holds the sensor unit 20, and in the fixing region Sa for the sensor unit 20, a release agent is removed by cutting.

### Examples

Tires according to Conventional Example and according to Examples 1 to 10 were manufactured. The tires each have a tire size of 275/40R21 and include at least one sensor unit including a sensor that acquires tire information, and the sensor unit is bonded to an innerliner constituting a tire inner surface via an adhesive layer. A method for removing a release agent, a ratio of the thickness Wa of the innerliner to the thickness Wb of the innerliner (Wa/Wb×100%), the adhesive strength of the adhesive layer, and the type of an adhesive are set as indicated in Table 1.

Note that, in Conventional Example, vulcanization was performed in a state where the release agent was applied to the tire inner surface, and no work of removing the release agent after the vulcanization was performed. In Conventional Example and Examples 1 to 10, a liquid adhesive was used as the adhesive layer.

The test tires were evaluated for the adhesiveness of the sensor unit, air retention properties, tire productivity, and adhesion workability by a test method described below. The results of the evaluation are also indicated in Table 1.

### Adhesiveness of Sensor Unit

Adhesiveness of the sensor unit as used here indicates evaluation of peeling in an adhering surface between the tire inner surface and the sensor unit. Each of the test tires was mounted on a wheel having a rim size of 21×9.5 J, and a running test was performed by using a drum testing machine at an air pressure of 250 kPa and a load of 6.5 kN. After the test was started at an initial speed of 170 km/h, the speed was increased by 10 km/h every 10 minutes until the speed reached 300 km/h, and presence of falling off or peeling of the sensor unit was visually observed. The case where there is no falling off and no peeling of the sensor unit is indicated by “excellent”, the case where less than ⅛ of all the sensor unit peeled is indicated by “good”, the case where ⅛ or more and less than ¼ of all the sensor unit peeled is indicated by “fair”, and the case where ¼ or more of all the sensor unit peeled is indicated by “poor”. Air Retention Properties

Each of the test tires was mounted on a wheel having a rim size of 21×9.5 J, and left for 24 hours at an air pressure of 270 kPa and a temperature of 21° C. Then, an initial air pressure of 250 kPa was set, and air pressure was measured for 42 days. An inclination of an air leakage amount from the 15th day to the 42nd day was determined. The evaluation results are expressed as index values by using reciprocals of measurement values, with Conventional Example being assigned as the reference 100. The larger index values mean excellent air retention properties.

### Tire Productivity

For each of the test tires, manufacture time (minutes) required to manufacture one tire was measured. The evaluation results are expressed as index values by using reciprocals of measurement values, with Conventional Example being assigned as the reference 100. The larger index values mean excellent tire productivity.

### Adhesion Workability

For each of the test tires, time (minutes) required for work of bonding the sensor unit to the tire inner surface was measured. The evaluation results are expressed as index values by using reciprocals of measurement values, with Conventional Example being assigned as the reference 100. The larger index values mean excellent adhesion workability.

TABLE 1

| | Conven- | | | | | | | | | | |
|---|---|---|---|---|---|---|---|---|---|---|---|
| | tional | Example | Example | Example | Example | Example | Example | Example | Example | Example | Example |
| | Example | 1 | 2 | 3 | 4 | 5 | 6 | 7 | 8 | 9 | 10 |
| Method for | — | Buffing | Buffing | Buffing | Buffing | Buffing | Buffing | Buffing | Buffing | Buffing | Buffing |
| removing | | | | | | | | | | | |
| release agent | | | | | | | | | | | |
| Ratio of thickness | — | 0% | 10% | 15% | 55% | 95% | 99% | 55% | 55% | 55% | 55% |
| Wa of innerliner to | | | | | | | | | | | |
| thickness Wb of | | | | | | | | | | | |
| innerliner (Wa/Wb × | | | | | | | | | | | |
| 100%) | | | | | | | | | | | |
| Adhesive strength | 0.4 | 0.4 | 0.4 | 0.4 | 0.4 | 0.4 | 0.4 | 5.0 | 100 | 5.0 | 5.0 |
| of adhesive layer | | | | | | | | | | | |
| (N/mm²) | | | | | | | | | | | |
| Type of | Reaction | Reaction | Reaction | Reaction | Reaction | Reaction | Reaction | Reaction | Reaction | Reaction | Instan- |
| adhesive | curable | curable | curable | curable | curable | curable | curable | curable | curable | curable | taneous |
| | adhesive | adhesive | adhesive | adhesive | adhesive | adhesive | adhesive | adhesive | adhesive | adhesive | adhesive |
| Adhesiveness | Poor | Good | Good | Good | Good | Good | Fair | Excellent | Excellent | Excellent | Excellent |
| of sensor unit | | | | | | | | | | | |
| Air retention | 100 | 94 | 95 | 96 | 98 | 100 | 100 | 98 | 98 | 98 | 98 |
| properties | | | | | | | | | | | |
| Tire productivity | 100 | 94 | 95 | 97 | 98 | 100 | 100 | 98 | 98 | 98 | 98 |
| Adhesion | 100 | 100 | 100 | 100 | 100 | 100 | 100 | 100 | 100 | 100 | 102 |
| Workability | | | | | | | | | | | |

As can be seen from Table 1, as compared to Conventional Example, in the pneumatic tires according to Examples 1 to 10, the adhesiveness of the sensor unit was enhanced while ensuring air retention properties. Further, in Examples 3 to 5 and 7 to 10, the ratio of the thickness Wa to the thickness Wb was set within a suitable range, and thus tire productivity was maintained. Particularly, in Example 10, the instantaneous adhesive was used, and thus adhesion workability was improved.

1. A pneumatic tire, comprising:
at least one sensor unit comprising a sensor that acquires tire information, the sensor unit being fixed to an innerliner constituting a tire inner surface; the sensor unit being bonded to the tire inner surface via an adhesive layer in a state where a release agent present in the tire inner surface is removed by cutting at least in a fixing region for the sensor unit.

2. The pneumatic tire according to claim 1, wherein a thickness Wa of the innerliner in the fixing region for the sensor unit ranges from 15% to 95% of a thickness Wb of the innerliner in a region other than the fixing region for the sensor unit.

3. The pneumatic tire according to claim 1, wherein a thickness Wa of the innerliner in the fixing region for the sensor unit, a thickness Wb of the innerliner in the region other than the fixing region for the sensor unit, and a thickness We of the adhesive layer in the fixing region for the sensor unit satisfy a relationship of Wb≥Wa+Wc.

4. The pneumatic tire according to claim 1, wherein adhesive strength of the adhesive layer ranges from 0.4 N/mm² to 100 N/mm².

5. The pneumatic tire according to claim 1, wherein the adhesive layer is made of a cyanoacrylate-based adhesive.

6. The pneumatic tire according to claim 1, wherein the sensor unit is disposed in an inner side of a ground contact edge in a tire width direction.

7. The pneumatic tire according to claim 1, wherein the sensor unit is bonded directly to the tire inner surface.

8. The pneumatic tire according to claim 1, wherein a base is inserted between the sensor unit and the adhesive layer.

9. The pneumatic tire according to claim 1, wherein, as roughness of the tire inner surface in the fixing region for the sensor unit, arithmetic mean roughness Ra ranges from 0.3 μm to 15.0 μm and/or a maximum height Ry ranges from 2.5 μm to 60.0 μm.

10. The pneumatic tire according to claim 2, wherein the thickness Wa of the innerliner in the fixing region for the sensor unit, the thickness Wb of the innerliner in the region other than the fixing region for the sensor unit, and a thickness Wc of the adhesive layer in the fixing region for the sensor unit satisfy a relationship of Wb≥Wa+Wc.

11. The pneumatic tire according to claim 10, wherein adhesive strength of the adhesive layer ranges from 0.4 N/mm² to 100 N/mm².

12. The pneumatic tire according to claim 11, wherein the adhesive layer is made of a cyanoacrylate-based adhesive.

13. The pneumatic tire according to claim 12, wherein the sensor unit is disposed in an inner side of a ground contact edge in a tire width direction.

14. The pneumatic tire according to claim 13, wherein the sensor unit is bonded directly to the tire inner surface.

15. The pneumatic tire according to claim 14, wherein, as roughness of the tire inner surface in the fixing region for the sensor unit, arithmetic mean roughness Ra ranges from 0.3 μm to 15.0 μm and/or a maximum height Ry ranges from 2.5 μm to 60.0 μm.

16. The pneumatic tire according to claim 13, wherein a base is inserted between the sensor unit and the adhesive layer.

17. The pneumatic tire according to claim 16, wherein, as roughness of the tire inner surface in the fixing region for the sensor unit, arithmetic mean roughness Ra ranges from 0.3 μm to 15.0 μm and/or a maximum height Ry ranges from 2.5 μm to 60.0 μm.
